(19) United States
(12) Patent Application Publication
(10) Pub. No.: US 2007/0205329 A1
(43) Pub. Date: Sep. 6, 2007

(54) Rotating parachute with pitch adjusters

(76) Inventor: David T. Barish, New York, NY (US)

Correspondence Address: David T. Barish, Apt. 12C, 420 East 51st Street, New York, NY, 10022, US

(21) Appl. No.: 11/706,486

(22) Filed: Feb. 15, 2007

Related U.S. Application Data
(60) Provisional application No. 60/777,717, filed on Mar. 1, 2006.

(51) Int. Cl. B64D 17/02

(52) U.S. Cl. 244/145

(57) ABSTRACT

An autorotating parachute is formed of spaced apart flexible flat panels with the peripheral edges of the panels being formed as a succession of arcuate edges and wherein the central portion of the canopy is substantially free of panel material. Pitch adjuster lines between panels provide chordwise tension to improve performance by lowering the panel camber and increasing blade twist.

Windmilling parachutes have special design problems. During the deployment phase, high incidence and camber are needed to provide enough torque for the spinup. To obtain low, steady descent velocity, the rotor airfoils should have low-cambered, unseparated airflow.

In the initial inflation, as the rotor is increasing in diameter, the pitch adjusters are slack. When the rotor approaches full span, the adjusters become taut, and the increase in tension causes blade pitch angle change. The chordwise forces lower the panel camber. In addition to limiting the spacing between the panel tips, the adjusters serve to prevent the panel inversions in the event of severe turbulence.

### BRIEF DESCRIPTION OF DRAWINGS

FIG. 1 shows a plan view of the inflated parachute with the pitch adjusters (34) at the tip periphery. The leading edge pitch lines (14, 15) are shorter than the trailing edge pitch lines (16, 17) to provide high initial torque.

FIG. 2 is a side view which shows the tight adjuster lines producing counter-torque to change the angle of attack of the panels.

FIG. 3 shows the flat pattern of a means of producing a container in an approximately pyramidal configuration. Two triangular flaps (35) are located on opposite sides of the square base. When exposed to airflow, these asymmetric flaps produce torque to spin the container about its axis.

FIG. 4 illustrates the assembled bag folded and sewn with the main chute and the two risers (37) packed inside. One end of each riser is attached to a flap at the apex. The other ends are free. These are intertwined with the riser connected to the payload, and the three are twisted tightly in the opposite direction to the container's spin for a preset number of turns. They are then coiled and placed in retainer loops inside the container. The sewing near the apex can be loosely tacked or velcroed so that the initial snatch forces will allow the easy extraction of the main chute.

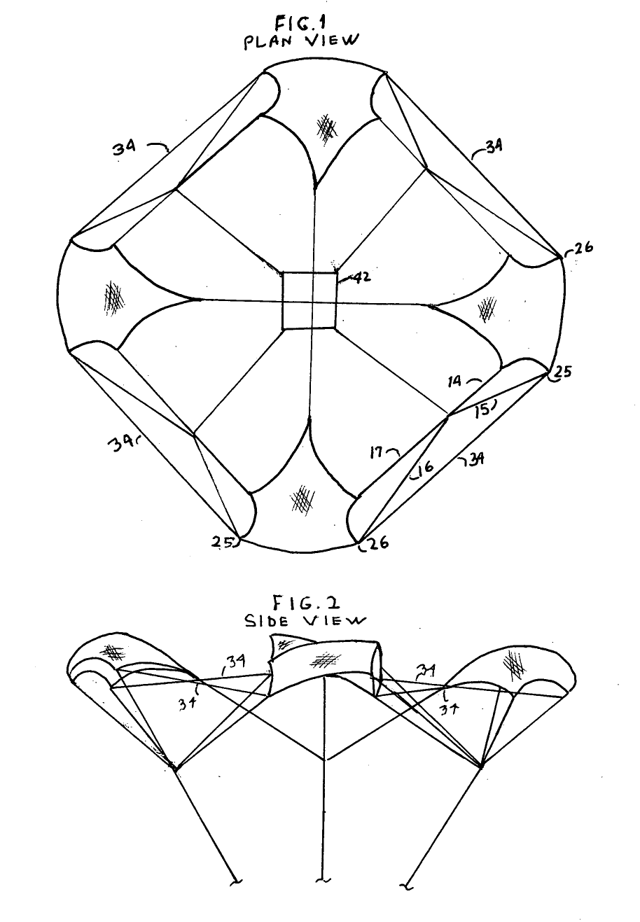

For designs involving high speeds, a means of delaying the release of the main parachute is required. Pyrotechnic cutters are frequently used, but the design shown offers a simple, inexpensive alternative.

On deployment, the coils are pulled from the retainers, and the line-stretch shock to the container is transmitted by friction between twisted lines. There is sufficient friction to prevent initial slippage. As the container rotates, the helix angle becomes more shallow until the risers part and the main stage canopy is pulled from the container.

For supersonic deployment the container includes two portholes located under the torque flaps (38). The ram air causes the container to inflate into a ballute-like configuration which provides additional stability during transonic deceleration.

What is claimed is:

1. An auto-rotating parachute having an axis about which the parachute rotates, comprising in combination:
A canopy formed of a plurality of relatively flexible, flat fabric panels, each having portions there of which are substantially equally and radially spaced from said central axis, each flat panel being defined by arcuate edge portions which intersect at acute or obtuse angled cusps; a skirt portion which is substantially straight.
Pitch lines cooperatively connected to said panels.
Pitch adjuster lines connecting the edges of the adjacent cusp portions.
A member capable of supporting a payload and being suspended from said panels by a plurality of suspension and pitch lines.
Said canopy being characterized by the absence of panel fabric within a predetermined radius about central axis, thereby forming a central panel-free zone through which the wake of the said member (42) and a payload is able to pass without substantially influencing the desirable autorotational characteristics of the parachute.

2. An autorotating parachute according to claim 1, wherein said panels are characterized by the absence of seams.

3. An autorotating parachute according to claim 1, wherein said panels are formed with peripheral edge tension members.

4. An autorotating parachute according to claim 1, wherein said cusps include interpanel connecting cusps and panel inboard cusps.

5. An autorotating parachute according to claim 4, wherein said panel inboard cusps are connected to a central axis.

6. An autorotating parachute according to claim 4, further comprising suspension lines connected at their respective lower ends to said support, and which are joined at the upper ends to pitch lines which are in turn attached to said cusps at the leading and trailing edge.

7. An autorotating parachute according to claim 1, wherein each of the panels includes an adjuster tension member which directly interconnects the adjacent skirt portions, lowering aerodynamic chordwise camber dependent upon the added tension at full inflation.

8. An autorotating parachute according to claim 7, wherein said leading edge portion includes at least two acute angled cusps defined by said arcuate portions and a skirt, and said trailing edge portion include at least two acute angled cusps defined by said arcuate portions and said skirt.

9. An autorotating parachute according to claim 7, wherein said peripheral edge tension members and the skirt line comprise a substantially integral and continuous line, which is looped back upon itself so as to form a substantially closed loop periphery for each panel and within which the panel fabric is disposed.

10. An autorotating parachute according to claim 1, further includes means for holding the interpanel lines and the adjacent cusps together during parachute deployment, to produce a relatively higher geometric solidity so as to cause more rapid inflation.

11. An autorotating parachute according to claim 10, further comprising means for holding and releasing means after inflation has begun.

12. An autorotating parachute according to claim 11, wherein said releasing means comprises a connector formed with a portion having a predetermined failure threshold influenced by inflation loads.

13. An rotating parachute according to claim 11, wherein the holding means comprises an open-ended tube.

14. An autorotating parachute according to claim 5, comprising at least one suspension line extending from the interconnected inboard cusps at the central axis to the payload support member.

15. A deployment bag with asymmetric external flaps to provide initial rotation of the stowed parachute.

16. A deployment bag according to claim 15 with risers to be intertwined with the payload riser.

17. A deployment bag according to claim 15 with internal stowage loops to hold the intertwined risers in tightly coiled condition with sufficient friction surfaced to prevent slippage due to the snatch force.

18. A deployment bag according to claim 15 with means for untwisting and orderly release and untwisting of the risers as the bag spins up.

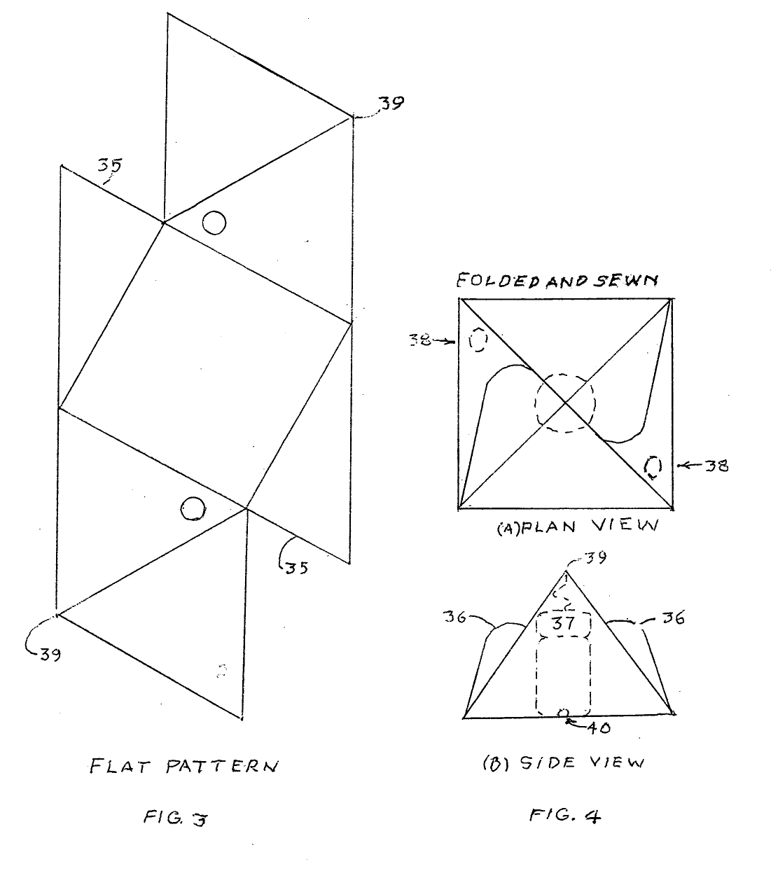

19. A deployment bag according to claim 15 with internal retention loops on the inside space of the deployment bag to stow the interpanel lines and pitch adjuster lines, thereby holding the opposing edges of the panels of the main parachute of claim 1, and increasing the effective geometric solidity during the initial inflation of the panels. (40) in FIG. 4 indicates the location of the internal retention loop for the stowage of the interpanel lines.

20. A deployment bag according to claim 15 with two intake holes in the corners of the front triangles under the torque flaps. The venting will cause the rapid inflation of the bag into a ballute-like shape and permit stable rotating deceleration even at supersonic deployment.
